(19) United States
(12) Patent Application Publication
(10) Pub. No.: US 2006/0008343 A1
(43) Pub. Date: Jan. 12, 2006

(54) Trailer that kneels to de-cantilever drawer under raised liftgate

(76) Inventor: Ray Howard, Victoria (CA)

Correspondence Address: RAY HOWARD, 1751 DENMAN ST., VICTORIA, V8R1Y3, CA

(21) Appl. No.: 11/170,000

(22) Filed: Jun. 29, 2005

Related U.S. Application Data
(63) Continuation-in-part of application No. 10/677,991, filed on Oct. 3, 2003.

(51) Int. Cl. B60P 1/64

(52) U.S. Cl. 414/498

(57) ABSTRACT

A vacation trailer in which, besides usual features, a special combination is provided, of trailer kneeling means and a removable cargo drawer providing substantially the same amount of floor space on which to load cargo as there would be if the trailer floor were loaded directly upon, which it is not. With a rear liftgate upraised, and after the drawer will have easily been rolled rearwardly into a horizontal cantilevered position, it is easy to drop one end of the loaded drawer to the ground without risking muscular strain or crushing someone's foot, by operating the kneeling means to tilt and dump the loaded drawer.

### CROSS-REFERENCE TO RELATED APPLICATION

This is a continuation-in-part of U.S. patent application Ser. No. 10/677,991 filed Oct. 3, 2003 by Raymond F. Howard and entitled KNEELING VACATION TRAILER WITH UPSWINGING REAR DOOR, REMOVABLE CARRIER AND DETACHABLE BUMPER.

### BACKGROUND OF THE INVENTION

1. Technical Field

The present invention relates to land vehicle structure for a specially constructed towed vacation trailer of a kind useful to vacationers who prefer taking their own overnight accomodations along with them on a motoring tour instead of staying at motels.

A different set of opportunities arises for devisers of towed land vehicle structure, as distinguished from structure for self-propelled land vehicles, because the latter typically have passengers inside their internal volumes during travel on the road. The fact that no part of space within towed trailer structure is occupied by anyone during road travel makes available virtually the entire interior open volume for personal cargo of all kinds. Since available cargo-carrying space tends to be filled up, it becomes a challenge to find how to most conveniently unload the cargo after ceasing road travel, in order to clear space in the trailer for the accomodation function intended.

Here then is where the below-claimed structure excels, since the present invention particularly relates to coordinating actions of moving, motion-guiding, and motion limiting elements of structure, functional interrelation of which, to be successful, requires specially executed coordination.

As will be explained below, reversal of the process of setting up, typically for the night, procures convenience respecting getting back on the road again for more travel, typically the next morning after an overnight stop.

2. Description of Related Art

What those of skill in the art will instantly recognize as “liftgate” rear doors on land vehicle structures are known to be useful for roofing over an area underneath a liftgate door pivoted upwardly to a horizontal position. An example of such use is disclosed by Sylvester, et al., whose “VAN CAMPER” got them U.S. Pat. No. 4,867,502 (Sep. 19, 1989). Although good service for roofing over the area beneath it is shown by the liftgate rear door of “VAN CAMPER”, its pivoting upwardly to a horizontal positioning procures no function assistive to unloading cargo, except of course in the normal way of opening access to enclosure structure. The present inventor has identified as desirable: to find some way whereby liftgate door raising shall assist cargo unloading, in some manner coordinated with other moving elements.

Looking elsewhere for unloading aspects of related art, in U.S. Pat. No. 6,722,726 issued to J. Parmer for a “TOY-HAULING TENT TRAILER” (Apr. 20, 2004), cargo unloading means specifically takes the form of a “modular folding wall unit” that converts to a ramp.

The present inventor has considered, but rejects, the concept of converting a wall-forming unit like Parmer's to a ramp. It desirable to unload cargo without depriving a vacation trailer of any portion of its wall, especially where the trailer is not a “tent trailer”, as is Parmer's, to which wall section removal to provide a ramp is not problematic in that case because tenting material will cover the vacant plane left by wall section removal.

There are existing trailer structure designs relevant to consider because they obviate need for an independent ramp, eliminable by providing, for example, some mechanism functional in a tilting and dumping manner to conveniently unload cargo. One instance of implementing this concept is disclosed by Hurlburt, whose “TRAILER HAVING TILT AND DUMP FUNCTIONS” got him U.S. Pat. No. 6,527,494 (Mar. 4, 2003). The Hurlburt trailer has two frames, one a special “tilt frame” which bears pivoting means whereby loading/unloading of cargo rested on the floor of the second frame, a “bed frame”, is enabled without an independent ramp. Pivotal movement of the bed frame about a transverse “dump axis” can so position the rearwardmost bed frame member immediately adjacent the surface of the ground, that a wheeled vehicle or cart can be rolled directly from the ground up onto the tilted trailer bed frame, or if already aboard can roll down and off it.

The present inventor rejects the Hurlburt trailer's embodied concept of relative motion between a tilting “bed frame” and hitch-attached “tilt frame” bearing pivoting means establishing a transverse axis about which the bed frame tilts. The two frames are considered by the present inventor to number one too many, in view especially of availability of kneeling suspensions which may be adapted to procure similar results to that of a two-framed trailer like Hurlburt's.

A different mechanism than Hurlburt's that conceivably also could lower the rear end of a trailer into contact with the ground may be provided by suitably modifying an adjustable suspension system like that of Heider et al., whose “SUSPENSION AND LEVELLING SYSTEM FOR A VEHICLE” got them U.S. Pat. No. 4,733,876 (Mar. 29, 1988). The modification needed would involve changing from the explicitly disclosed mode of operation of the apparatus of Heider et al., designed for side-to-side levelling. This could be changed to a front-to-rear type levelling function.

However, irrespective of selecting either a tilt-and-dump system or, in its place, an adjustably levelled suspension system, for lowering a trailer's rear end to the ground, so as to enable wheeled vehicles or carts to roll onto or from a trailer's floor, thereby eliminating need for a ramp, the idea itself of contacting the ground to make a trailer's floor, so to speak, “self-ramping” creates a problem recognized by the present inventor, who rejects contacting the ground as Hurlburt proposes. The problem is that then the trailer cannot be pulled forward even so little as half a meter, let alone about two meters, without likelihood of scraping the ground, disfiguring it, and thereby giving cause for complaint to a party vending overnight space to vacation trailer parkers.

Warranting explanation next, in connection with pulling a trailer forward when setting up for overnight self-accomodations, is how and why the abovecited parent application included a proposal to pull the trailer forward for a predetermined distance right after detaching a removable bumper having a cavity in which a sufficient amount of fabric stores, for use erecting sheltering sidewalls hung from the upraised liftgate door at the trailer's rear. This feature was considered a combinatory element working in coordinated fashion with other elements.

Since the time of the parent disclosure, the present inventor has abandoned the concept of making the hollow detachable bumper storing shelter-walling fabric essential, choosing now that its presence should be optional. To so change conceptions is a material issue involving new subject matter, the inventor thinks.

A reasonable artisan presumed to have inspected the parent application may well have deduced that the proposed pulling forward of the trailer in course of setting up can be omitted if only the detachable bumper element (as then described) were not present. However, such a deduction does not carry over to the specifications disclosed hereinafter, because another vacation trailer element, which was essential previously and remains so now, itself requires the pulling forward of the trailer (without scraping the ground), for a reason best explained after first briefly discussing the fact that the art is well apprised of cargo being disposed in wheeled carts carried on a trailer.

The disclosure by DiBartolomeo of “MATERIALS-HANDLING CARTS WITH REMOTELY CONTROLLED DECOUPLING” got him U.S. Pat. No. 6,149,370 (Nov. 21, 2000). A feature of DiBartolomeo's way of loading and unloading land vehicle-transported cargo using wheeled carts is utilization of delatchable retention means whereby, after a cart will have been positionally secured by latching before transport, followed by transport by the vehicle, then by cessation of transport due to arrival at the destination, the cart may be delatched from retention in the transport position, just before unloading. Unloading as expressly contemplated in DiBartolomeo's description typically involves rolling the cart horizontally onto a receiving dock at the same height as the bed of the transport vehicle from which the cart rolls out.

Implicitly, artisans in the field will appreciate that a cart having the delatchable feature of DiBartolomeo's might, instead of being rolled horizontally out onto a loading dock, be rolled down a ramp like Parmer's, or a tilted trailer bed frame like Hurlburt's. If so, however, the difference would not be expected to be significant, so long as delatching of the cart is effected prior to its exiting the trailer, in the usual manner described by DiBartolomeo, whose invention's mode of operation clearly is not intended to permit dropping a rearwardly protruding cart off the transport vehicle bed. Nor there intention that the latching means for secure cart retention in a transport position should be designed to prevent a rearwardly protruding cart from dropping to the ground. Thus, the timing of delatching from a secured position, as proposed by DiBartolomeo respecting his carts, invokes an altogether different treatment of subject matter than in unloading the vacation trailer of the present invention, as will be understood in due course, when cantilevering and de-cantilevering of the special cargo drawer of the present invention is explained.

Also of pertinence to the below-described unique mode of removing personal cargo from the present vacation trailer, is the fact that wheeled carts like DiBartolomeo's normally utilize sets of wheels at opposite ends, such that, if such a cart were rolled down a ramp, or alternatively down from a tilted trailer bed frame, the one set of wheels at one end of the cart will surely contact the ground before the other leaves the ramp or alternatively trailer bed frame. As a result of the first exiting set of wheels contacting the ground, an only partially removed cart, left partly in contact with ramp or trailer bed, will be rendered too unstable for it (the cart) to be used itself as a ramp extension, unless something is done, like locking the front wheels.

Insofar as the present inventor is aware, even though none of the various physical components to be combined in the invention are either individually rare or unavailable, or hard to fabricate, their combination with one another, to make the whole machine which is the vacation trailer claimed below as the invention, has not been anticipated by the acknowledged related art.

### BRIEF SUMMARY OF THE INVENTION

The broad purpose, or ie., object, of this invention is attainment of rapid and convenient setting up of accomodations for which a vacation trailer is intended, but that is impeded by needing to clear the trailer body's interior volume of outdoor portables carried as personal cargo. The term “outdoor portables” has here the same meaning as in the parent application cited above, which is hereby requested for incorporation in entirety herewith by reference.

Typical vacationer's cargo of outdoor portables crowded into a vacation trailer while it is being towed includes items such as folding chairs, a card table, a portable barbecue, bicycles or motorcycles, tool boxes, a wheelchair, and the like, all which are all in the way, obstructing use in the trailer body interior of its typical built-in kitchenette and sleeping area until such cargo will have been removed.

A specific object of the invention is to put a ramp-like element in position for use by a person in a wheelchair to roll into a vacation trailer through its rear opening as soon as outdoor portables will have been unloaded from the trailer and disposed in an outdoor living area adjacent the parked vacation trailer.

Some specific technical objects the invention is to meet correspond to rejections of identified aspects of related art contrivances for cargo unloading. One such object is to provide a ramp-like unloading/loading element that converts to ramp use from another use, where the latter must not be formation of part of the trailer body's wall (contrary to Parmer).

Another specific technical object is to provide a feature allowing the trailer to be pulled forward with an element slanting to direct contact with the ground, without scraping the ground (contrary to Hurlburt's approach, with a tilted trailer bed which would scrape the ground).

Since a wheeled carrier is to be employed, another technical object is to provide one that does not place wheels at the lower end in contact with the ground (as DiBartolomeo's wheeled carts would), when the carrier serves as a ramp.

The foregoing broad object and also specific technical objects of the invention, together with other objects that will become apparent in due course, have all been found to be met by making the overall structure of a vacation trailer to be as is described in full detail further below.

Fundamentally, the presently disclosed vacation trailer has an overall structure comprising, in functional combination with one another, some conventional and some new special features, arranged to interact in a clearly new manner deriving optimal advantage from utilizing, as an essential element, a cantileverable drawer that fits so well and closely into the open space volume of the trailer body interior, that the floor area of this drawer is substantially similar in size to that of the trailer floor, exclusive of built-in raised bed areas and built-in kitchenette appurtenances. This special trailer-fitting drawer shall be termed the “cargo drawer”. Outdoor portables during towing rest on the cargo drawer's floor, not the trailer's, thereby being ready for removal en masse from the trailer, according to a mode of operation different from that of a wheeled cart plus a ramp.

Details of interaction of the cargo drawer with other key elements will make clear that this trailer invention is not an obvious aggregation of cart and ramp features. The drawer, for example, is not a cart, really, and to be rolled out of the trailer requires to rest on a roller built into the trailer body floor. The drawer fits so snugly into the trailer body that there can be no back and forth rolling on the roller, until the liftgate is opened, after which the roller becomes effective, supporting the unwheeled end of the cargo drawer during the drawers travel horizontally into a cantilevered position beneath the upraised liftgate. For another example of features' interaction, the kneeling suspension means will have a tilting functionality range designed both for avoiding ground contact by any trailer body portion and for de-cantilevering the protruded cargo drawer so that one end of it will contact the ground. These and other features specified in detail are arranged to interact in a manner highly effective to satisfy the objects of the invention, and the invention as a whole is best learned by taking reference to the several figures of drawing, next enumerated.

### BRIEF DESCRIPTION OF THE DRAWING

FIG. 1 is a partially cut-away side view of the trailer shown unkneeling.

FIG. 2 is a view like FIG. 1, but with the trailer's liftgate raised and its cargo drawer cantilevered in partial rearward emergence.

FIG. 3 is a third side view, here showing the trailer kneeled, with the result of de-cantilevering the cargo drawer.

FIG. 4 is a fourth side view, here showing how the cargo drawer becomes positioned like a ramp after the trailer is pulled forward.

FIG. 5 is a fifth side view to illustrate the cargo drawer completely removed from the trailer, and sheltering fabric walling material hung from the upraised liftgate.

### DETAILED DESCRIPTION OF THE INVENTION

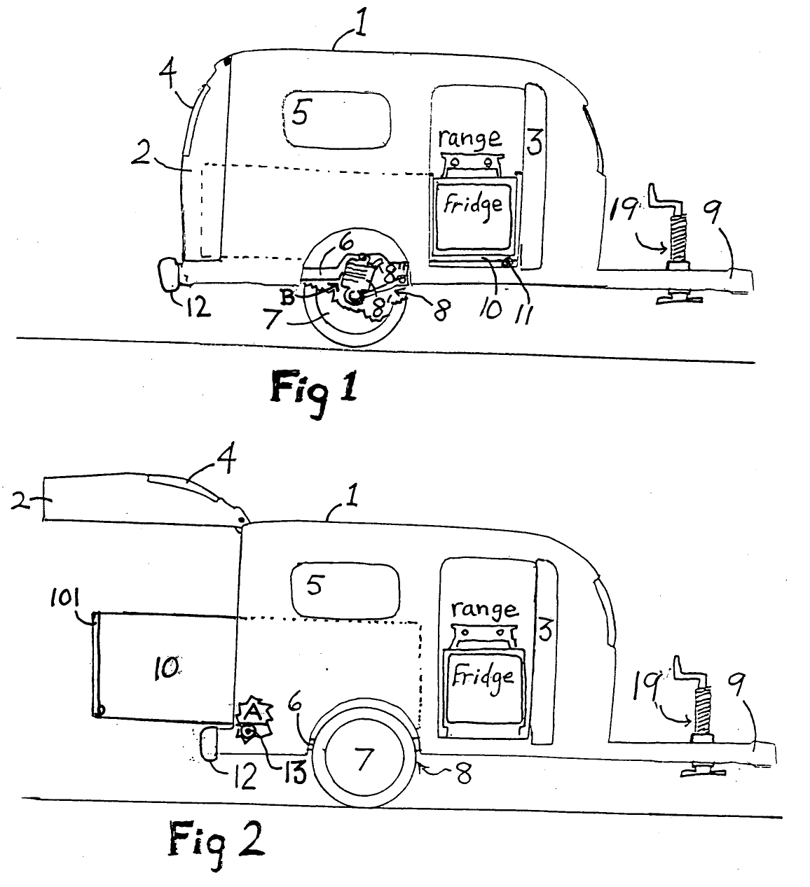

A basic preferred version of a vacation trailer that embodies the present invention is illustrated by the five side view figures, FIGS. 1-5. To those who are well acquainted with the molded fiberglass-bodied trailers formerly made in Winnipeg, Manitoba, Canada by Boler Manufacturing Limited, the illustrated trailer, especially as shown in FIG. 1 before the liftgate 2 rear door is raised, exhibits a similar overall shape-resemblance and layout. A similar height-to-width-to-length proportioning is intended. A rounded edges/rounded cornered molded body 1 is much like that of Boler trailers. Siting of rear and side windows, respectively enumerated 4 and 5, and a side door 3 (shown open) are further conventional features resembling those of Boler trailers. Other conventional features include: a chassis 6, with the usual forward extension of a “tongue” terminating in a towing hitch device 9, near which a lowerable tongue support 19 is mounted for use when the trailer is unhitched from a towing vehicle. An ordinary bumper 12 is provided at the rear of the trailer as usual.

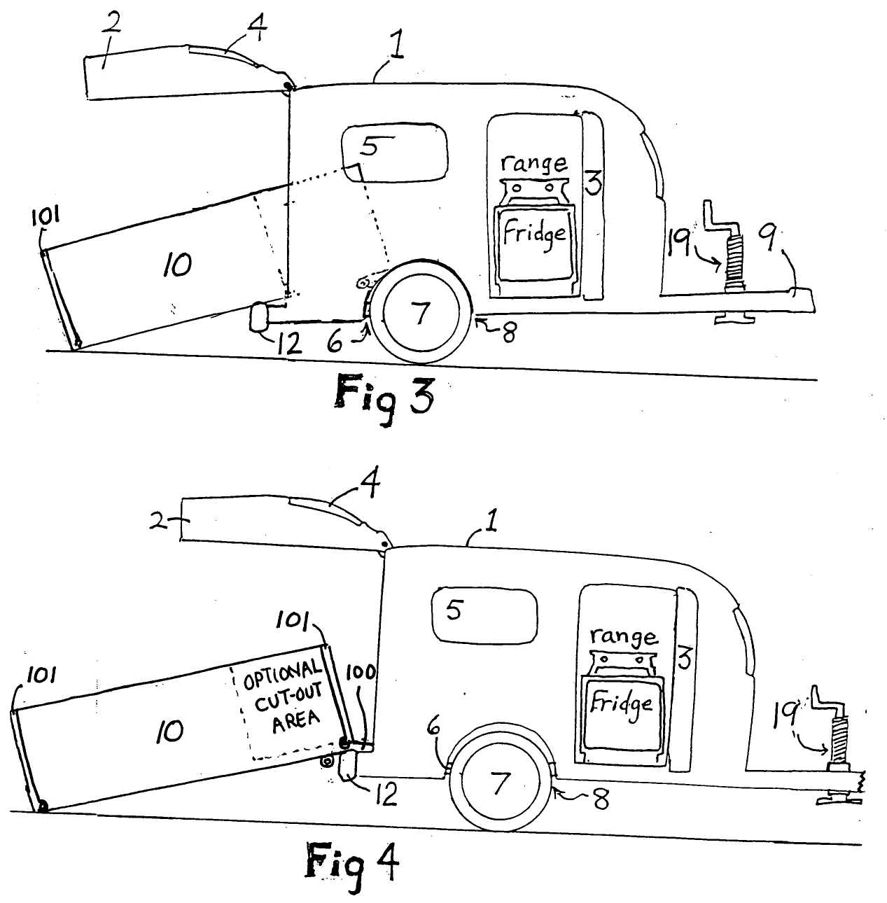

Shown in FIG. 1's cutaway area B, suspension means 8 connects between roadable wheel 7 and chassis 6, a counterpart wheel set at the opposite (unshown) side of the trailer being also present. Suspension means 8 has a variably expansible air bellows 8′ to which compressed air is fed via valve-controlled air line 8″. Opening a valve (not shown) to release air from bellows 8′ for suspensions 8 at each of the opposed wheels 7 is effective to cause the trailer to kneel toward its rear, ie., to tilt downwardly toward the ground near bumper 12. The kneeling action is not shown until FIG. 3, because another aspect of subject matter requires first being described with reference to FIG. 2.

As soon as a trailer embodying the present invention has its liftgate 2 upraised and held open by suitable means, as shown in FIG. 2, the above-noted shape resemblance to the popular trailers made by Boler Manufacturing Limited no longer is strongly apparent. Moreover, partially emerged through the opening in the rear of trailer body 1, what has been pushed or pulled into a cantilevered horizontal position is unique cargo drawer 10 of the present invention. No known vacation trailer has ever had this feature, which is a long open-topped drawer 10 size-scaled to fit into the interior of trailer body 1 in order to afford a support structure on which substantially all personal cargo of the nature of “outdoor portables”, as explained above, may rest, instead of on the actual floor inside trailer body 1. For optimized utility, the length of cargo drawer 10 should be at least about four-fifths of the interior floor length of trailer body 1.

Cargo drawer 10 has, attached to its underside at one end only thereof, parallel sets of strong small wheels 11. The end with wheels 11 fits farthest into trailer body 1 toward the end nearest hitch 9. Wheels are not normally attached to the end of drawer 10 that rearwardly emerges first from trailer body 1. For rolling support of this first-to-emerge end, there is, as shown in cutaway area A, a roller 13 installed in the floor of trailer body 1 near the rear opening which is closed during towing by liftgate 2 in its closed, ie., vertical, position.

Taking into account now the illustrated description thus far provided by FIGS. 1 and 2, a typical step-by-step process leading up to what is shown in FIG. 2 can take place in the manner next described.

The towed trailer, by control of the still-attached towing vehicle, shall be stopped at a location slightly behind the anticipated trailer-parking spot. The vacationer, either the tow vehicle's driver or a companion, then exits the tow vehicle, walks around to the rear of the trailer, and then operates a usual handle-and-latch mechanism to open liftgate 2, then raising it to the upraised horizontal position shown in FIG. 2. Next, cargo drawer 10 is to be pulled into the partly emerged cantilevered horizontal position shown, taking care to not pull it out so far that its emergent end will drop at this moment. Although the figures do not show outdoor portables as cargo ladening drawer 10, they may be assumed present in a well centered arrangement placing a center of gravity of the load approximately aligned with the midpoint of cargo drawer 10's length. The next step requires reference to the next figure, FIG. 3.

Once drawer 10 has been shifted rearwardly far enough that the center of gravity of its load will be aligned in the vicinity of roller 12, without being rearward of that point, then without risking muscular strain or dropping the load on someone's foot, air shall be let out of both bellows 8′ of suspensions 8, with the result that rearward kneeling of trailer body 1 will cause cargo drawer 10 to de-cantilever from the horizontal plane, tilt, and drop its rearward emergent end to the ground, thereby leaving the drawer temporarily in the position shown in FIG. 3.

A step of pulling the trailer forward a predetermined distance by means of the towing vehicle causes lip element 100 at the end of drawer 10 nearest the trailer body 1 floor to drop into position at the floor's rearmost edge, leaving drawer 10 set like a ramp as in FIG. 4.

With reference also to FIG. 4, dropgate closures 101 at opposite ends of drawer 10, after being swung down, facilitate unloading all the cargo from drawer 10 and then using it in place as a ramp for an individual in a wheelchair to enter the trailer body 1 if desired.

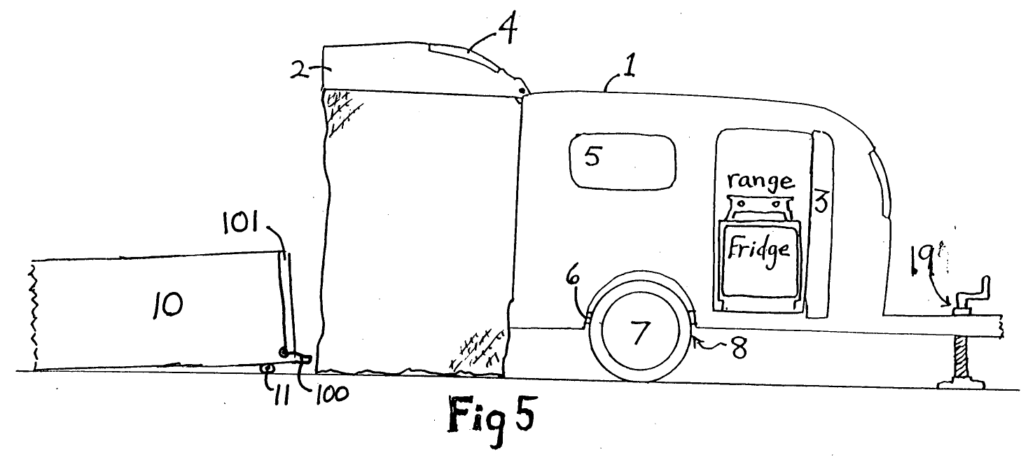

FIG. 5 illustrates the drawer 10 having been so unloaded and thereby lightened so that it can be manually pulled aside with no great difficulty, clearing the area immediately behind the trailer, where, by the simple expedient of suitably hanging sheltering fabric walling material 14 from upraised liftgate 2, a private area for changing clothes and so forth is established. FIG. 5 also shows, by virtue of hitching tongue support 19 being put into its conventional self-explanatory use, that the towing vehicle is now free to be driven about, eg., to a nearby store, leaving the trailer set up independently as a temporary home.

It will be apparent to artisans who have followed the foregoing description with reference to the five side view figures that the kneeling function of the new vacation trailer combines with the unique cargo drawer to provide a particularly effective labor-saving way to clear the interior of the trailer for almost immediate use for accomodations therewithin. Reflection upon the objects of the invention, recalled from the BRIEF SUMMARY section above, will persuade the artisans that the invention meets all its objects. It is thought that a unique mode of operation is demonstrated by how the elements of this trailer cooperate. A number of useful additions and modifications to basic structures, which will not require exercise of inventiveness, will almost certainly prove easily integrated into this novel vacation trailer without departing from the spirit and substance of what has been fully disclosed about it.

I claim:

1. For enabling convenient en masse unloading of personal cargo carried in a vacation trailer, construction of the trailer to include, in addition to conventional features of a chassis, a body having sides and a roof and a floor, suspension means, roadable wheels attached to said chassis by said suspension means, and a hitching device for towing said trailer, further combination therewith and with one another, of:
a liftgate rear closure that opens to a raised horizontal position;
a pair of expansible air-containing bellows forming integral parts of said suspension means whereby, by releasing air from said bellows said trailer is caused to rearwardly kneel;
a roller transversely mounted in said trailer body floor near where said liftgate rear closure opens; and,
adapted to roll backward in the direction away from said hitching device, in part rolling upon said roller, and in part rolling upon integral wheels, a cargo drawer constructed to fit into the interior of said trailer body so as to provide a floor of said drawer on which to carry cargo instead of carrying cargo on the trailer body floor;
whereby, when said trailer rearwardly kneels while said liftgate rear closure is open and said cargo drawer will have been pulled to a cantilevered position partly under said raised liftgate, said cargo drawer will tilt out of said cantilevered position, dropping one end of said drawer to the ground and leaving an opposite end temporarily raised above said trailer body floor until said trailer is pulled forward a predetermined distance.
